(19) United States
(12) Patent Application Publication
(10) Pub. No.: US 2013/0001060 A1
(43) Pub. Date: Jan. 3, 2013

(54) FLUID FRICTION-BASED DISTILLATION APPARATUS

(75) Inventors: Mazen A. Ba-abbad, Riyadh (SA); Hany Adulrahman Al-Ansary, Riyadh (SA); Essam A. Al Ammar, Riyadh (SA)

(73) Assignee: King Abdul Aziz City for Science and Technology, Riyadh (SA)

(21) Appl. No.: 13/172,600

(22) Filed: Jun. 29, 2011

(51) Int. Cl. B01D 3/02

(52) U.S. Cl. 202/175

(57) ABSTRACT

The invention provides an apparatus for frictionally heating one or more fluids to produce one or more distilled fluids and to separate impurities from the one or more fluids. The apparatus includes a housing for receiving the one or more fluids. The apparatus also includes one or more rotatable cylinders enclosed within the housing. The one or more rotatable cylinders include a plurality of friction elements. On rotating the one or more rotatable cylinders, the impurities are separated from the one or more fluids and the plurality of friction elements frictionally interact with the one or more fluids to generate vapors. Thereafter, the one or more impurities are collected in an impurity collector associated with the housing. The vapors generated due to the frictional interaction are received by one or more condensers which condense the vapors to produce one or more distilled fluids.

### FIELD OF THE INVENTION

The present invention generally relates to distillation of fluid mixtures, and more specifically, to an apparatus for frictionally heating one or more fluids to produce one or more distilled fluids and to separate impurities from the one or more fluids.

### BACKGROUND OF THE INVENTION

Existing methods for separating one or more fluids and one or more impurities from fluid mixtures include various distillation systems. Distillation involves heating of fluid mixtures to produce vapor which is collected and condensed to produce a distilled fluid. Distillation systems such as, boiler-type distillers, thin-film distillers, and vacuum distillers require a large amount of heat for converting the fluid to vapor. These distillation systems require an external source of heat and are hence expensive for large scale productions. Further, these distillation systems result in production of a concentrated liquid discharge and the amount of distilled fluid obtained is also low.

Separation of one or more fluids and one or more impurities from fluid mixtures may also be performed using reverse osmosis. In reverse osmosis, a semi-permeable membrane is used to separate the one or more impurities from the one or more fluids by applying a pressure on the one or more fluids. However, these semi-permeable membranes may be susceptible to heat and sensitive to chemicals in the one or more fluids. Further, the one or more fluids may also need special pre-treatment prior to the separation process. Pre-treatment may be performed in order to alter pH of the one or more fluids or to remove dissolved chemicals in the one or more fluids. Alternatively, pre-treatment may be performed to remove larger solid impurities from the one or more fluids.

Further, salt crystallizers may be used to produce solids from concentrated liquid solutions. However, these salt crystallizers are complex, very large, and expensive to operate.

Therefore, there is a need for a compact and cost effective apparatus for distilling fluid mixtures and separating impurities from the one or more fluids.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the invention.

FIG. 1A illustrates a perspective view of an apparatus for distilling one or more fluids in accordance with an embodiment of the invention.

FIG. 1B illustrates a cross-sectional view of the apparatus for distilling one or more fluids in accordance with an embodiment of the invention.

FIG. 2 illustrates a bottom perspective view of the apparatus depicting a condenser for condensing vapor in accordance with an embodiment of the invention.

FIG. 3 illustrates a cross-sectional view of an apparatus for distilling one or more fluids in accordance with another embodiment of the invention.

FIG. 4A illustrates a perspective view of an apparatus for distilling one or more fluids in accordance with another embodiment of the invention.

FIG. 4B illustrates a perspective inner view of an apparatus for distilling one or more fluids in accordance with another embodiment of the invention.

FIG. 5 illustrates a perspective inner view of the apparatus of FIG. 4B depicting one or more openings for facilitating the flow of one or more impurities from one or more rotatable cylinders to the housing.

FIG. 6 illustrates a perspective view of a portion of a condenser associated with the apparatus of FIG. 4A and FIG. 4B for condensing vapor.

FIG. 7 illustrates a top view of the apparatus of FIG. 4A and FIG. 4B depicting a plurality of electromagnets for rotating one or more cylinders.

FIG. 8 illustrates a perspective view of an apparatus for distilling one or more fluids in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to a fluid friction-based distillation and processing system. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Generally speaking, pursuant to various embodiments, the invention provides an apparatus for distilling one or more fluids. The apparatus includes a housing for receiving the one or more fluids. The one or more fluids may include one or more impurities. The apparatus also includes one or more rotatable cylinders enclosed within the housing. The one or more rotatable cylinders include a plurality of friction elements on one or more of an inner wall and an outer wall. In response to rotation of the one or more rotatable cylinders, the plurality of friction elements frictionally interact with the one or more fluids to generate one or more vapors. The rotation of the one or more rotatable cylinders further enables separation of the one or more impurities from the one or more fluids. Thereafter, the one or more impurities are collected in an impurity collector associated with the housing. The one or more vapors generated due to the frictional interaction are received by one or more condensers which condense the one or more vapors to produce one or more distilled fluids.

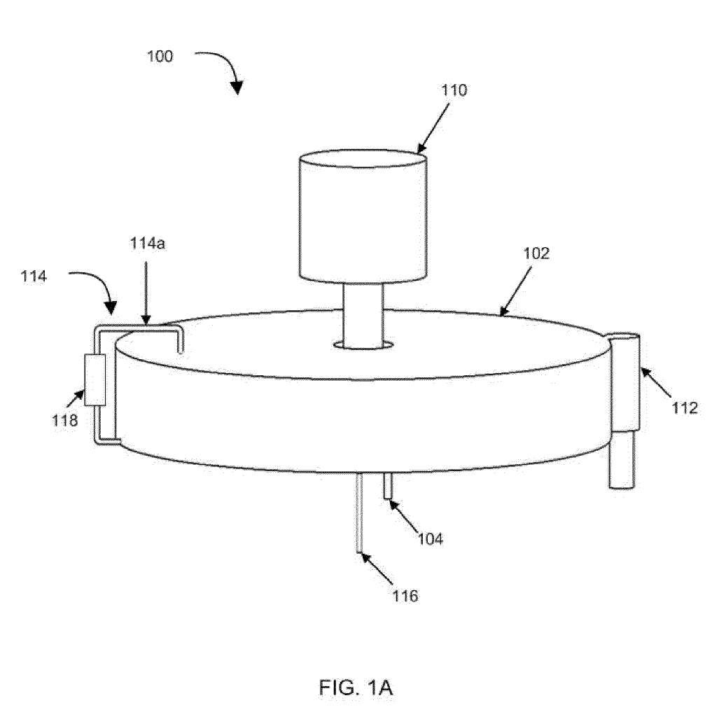

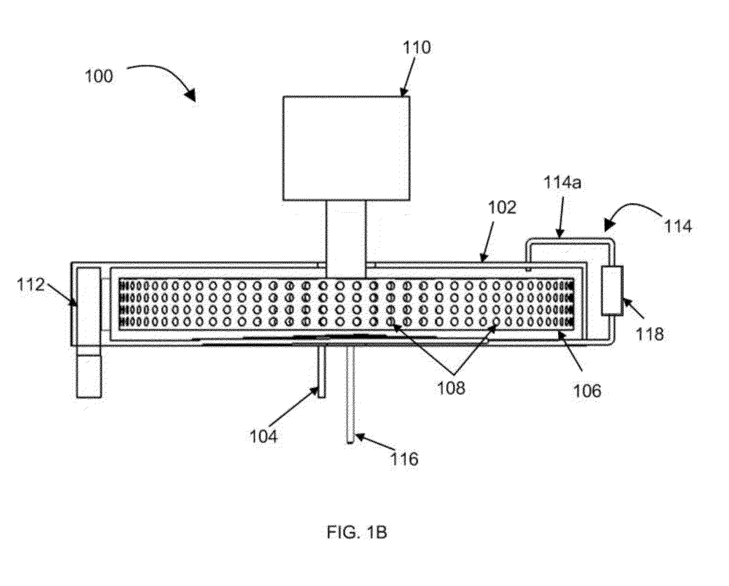

FIG. 1A and FIG. 1B illustrate a perspective view and a cross-sectional view respectively of an apparatus 100 for distilling one or more fluids in accordance with an embodiment of the invention. Here, the one or more fluids may include, but are not limited to, sea water, waste water, and crude oil. Apparatus 100 includes a housing 102 for receiving the one or more fluids (hereinafter referred to as “fluids”). The fluids may include one or more impurities such as one or more dissolved solids and one or more suspended solids. Apparatus 100 further includes a fluid inlet 104 for guiding the fluids to housing 102. A housing such as housing 102 may enclose one or more cylinders configured to be rotatable. The one or more cylinders may be concentric to an axis of housing 102. In an embodiment, housing 102 includes a rotatable cylinder 106 as illustrated in FIG. 1B. Here, each of the one or more rotatable cylinders may have both ends closed, both ends open, or one end closed and one end open.

Rotatable cylinder 106 includes a plurality of friction elements on one or more of an inner wall and an outer wall. In one embodiment, the plurality of friction elements include perforations such as, perforations 108 associated with rotatable cylinder 106. Alternatively, the plurality of friction elements may include, but are not limited to, corrugations, grooves, arcs, teeth, and ridges. Perforations 108 associated with rotatable cylinder 106 frictionally interact with the fluids in housing 102 on rotation of rotatable cylinder 106 to generate heat. A rotatable cylinder such as, rotatable cylinder 106 may rotate at high speed so that friction is caused to generate the heat. This heat causes the fluids to evaporate as one or more vapors.

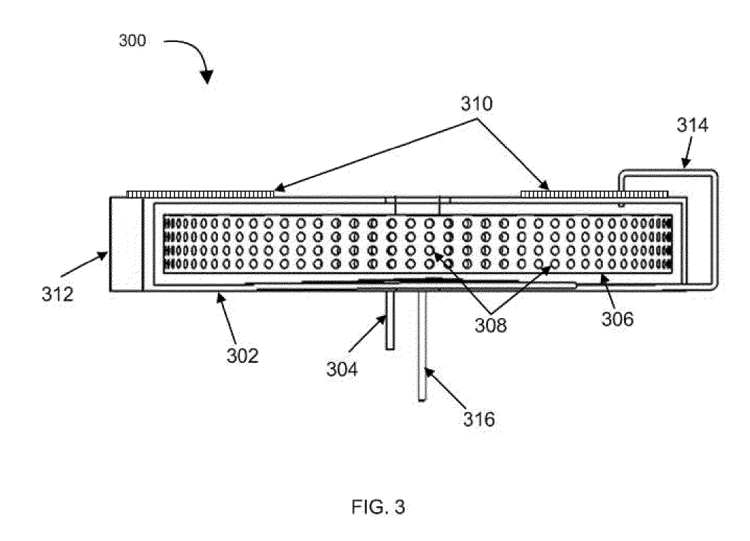

To rotate rotatable cylinder 106, one or more motors such as, a motor 110 is used. Motor 110 may be used to rotate rotatable cylinder 106 in one of a clockwise direction and a counterclockwise direction. Alternatively, a plurality of electromagnets may be used for rotating rotatable cylinder 106. This is explained in conjunction with FIG. 3. Apparatus 100 may additionally include a plurality of stabilizing electromagnets (not shown in FIG. 1) to prevent vibration of rotatable cylinder 106 during rotation. It will be apparent to a person skilled in the art that driving means for rotating rotatable cylinder 106 is not limited to one or more motors or a plurality of electromagnets but may include other means and combinations thereof known in the art.

In response to rotation of rotatable cylinder 106, a centrifugal force is generated which results in movement of the fluids into a lateral gap between rotatable cylinder 106 and housing 102. Thereafter, perforations 108 associated with rotatable cylinder 106 frictionally interact with the fluids to generate heat. Here, perforations 108 trap portions of the fluids during rotation of rotatable cylinder 106 and cause the portions of the fluids to frictionally interact with the remaining fluid in housing 102 to cause fluid friction. This friction causes an increase in temperature and eventually results in evaporation of the fluids as one or more vapors. Here, the fluids may have different boiling points and may form vapor at different temperatures. For example, crude oil may be separated into one or more fractions for specific uses such as transport, power generation and heating based on the different boiling points associated with the different fractions. Additionally, in response to the generation of the one or more vapors, one or more dissolved solid impurities in the fluids precipitate as crystals.

Further, the centrifugal force caused by the rotation of rotatable cylinder 106 separates suspended solid impurities from the fluids. The one or more of the one or more dissolved solid impurities and the one or more suspended solid impurities have a density higher than that of the fluids and are driven to impurity collector 112 due to the generated centrifugal force. To enable flow of these one or more impurities to impurity collector 112, one or more openings (not shown in FIG. 1) may be provided in rotatable cylinder 106. As a result of the centrifugal force, the one or more impurities swirl in impurity collector 112. The swirling of the one or more impurities prevents the one or more impurities from adhering to walls of impurity collector 112. The one or more impurities may then be removed from impurity collector 112 by one or more of, but not limited to, gravity settling and filtration techniques.

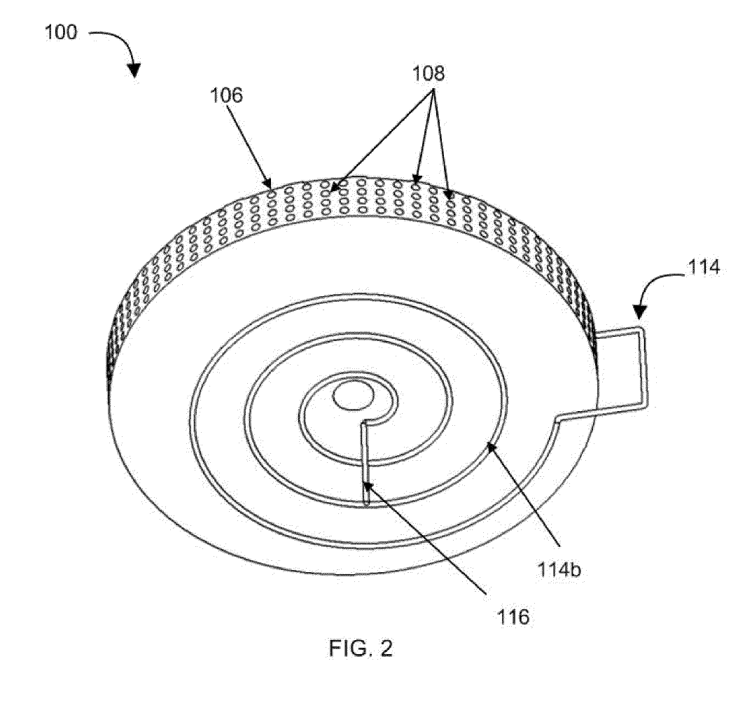

The vapor generated as a result of evaporation of the fluids is collected by one or more condensers such as a condenser 114. Condenser 114 includes a first portion 114a and a second portion 114b (illustrated in FIG. 2). In an embodiment, first portion 114a and second portion 114b of condenser 114 may be jointly fabricated as a single component. Second portion 114b of condenser 114 may have a shape including but not limited to a spiral shape as illustrated in FIG. 2. Here, second portion 114b is configured to exchange heat with the fluids. On exchanging heat with the fluids, the one or more vapors are condensed to produce one or more distilled fluids. In one embodiment, second portion 114b may be positioned at the bottom of housing 102 to enable efficient heat transfer with the fluids. However, second portion 114b may be positioned in any portion of apparatus 100 to facilitate the heat transfer with the fluids. On condensing the one or more vapors, the one or more distilled fluids may be collected through a fluid outlet 116 associated with condenser 114. The heat exchanged by condenser 114 with the fluids facilitates recirculation of heat back into apparatus 100.

Condenser 114 may further include one or more compression units such as compression unit 118 for compressing the one or more vapors. Compression unit 118 compresses the one or more vapors to increase condensation temperature of the one or more vapors. Here, compression unit 118 increases the pressure associated with the one or more vapors thereby increasing the temperature of the one or more vapors. The increased temperature allows the one or more vapors to exchange heat with the fluids at a higher temperature. For example, if the fluids include water, compression unit 118 increases the condensation temperature of the water to greater than 100° C., for example 110° C. This high temperature allows the water to exchange its latent heat with the fluids at temperature 110° C. Further, compression unit 118 facilitates reduction in boiling point of the fluids by exerting a vacuum on the fluids. Accordingly, compression unit 118 improves the exchange of heat between the vapor and the fluids.

FIG. 3 illustrates a cross sectional view of an apparatus 300 for distilling one or more fluids in accordance with another embodiment of the invention. Apparatus 300 includes a housing 302 for receiving the one or more fluids (hereinafter referred to as “fluids”). A fluid inlet 304 is configured for guiding the fluids into housing 302. Here, the fluids may include one or more impurities. Apparatus 300 further includes one or more cylinders configured to rotate within housing 302. A housing such as housing 302 may enclose one or more cylinders configured to be rotatable. The one or more cylinders may be concentric to an axis of housing 302. In an embodiment, housing 302 includes a rotatable cylinder 306. Here, housing 302, fluid inlet 304, and rotatable cylinder 306 are structurally and functionally similar to housing 102, fluid inlet 104, and rotatable cylinder 106 respectively of apparatus 100.

Rotatable cylinder 306 includes a plurality of friction elements on one or more of an inner wall and an outer wall. The plurality of friction elements may include a plurality of perforations such as, perforations 308 associated with rotatable cylinder 306. The friction elements may further include, but are not limited to, corrugations, grooves, arcs, teeth, and ridges. Perforations 308 associated with rotatable cylinder 306 frictionally interact with the fluids in housing 302 on rotation of rotatable cylinder 306 to generate heat. This heat causes the fluids to evaporate as one or more vapors. Here, the fluids may form vapor at different temperatures corresponding to the boiling temperatures associated with the fluids.

To rotate rotatable cylinder 306, a plurality of electromagnets may be used. In an embodiment, the plurality of electromagnets may include a plurality of superconducting magnets. In this case, the plurality of superconducting magnets suspends the one or more rotatable cylinders at a fixed distance from each other and also from the housing. This facilitates contactless rotation of the one or more rotatable cylinders. The plurality of electromagnets may be placed on the one or more rotatable cylinders and on the housing. Here, the plurality of electromagnets enables the one or more rotatable cylinders to rotate in one of a clockwise direction and a counter-clockwise direction. For example, a plurality of electromagnets may be placed on rotatable cylinder 306 (not shown in FIG. 3) and a plurality of electromagnets such as electromagnets 310 may be placed on housing 302 to enable rotation of rotatable cylinder 306. In an embodiment, the plurality of electromagnets may be placed on the external top surface of rotatable cylinder 306 and accordingly the plurality of electromagnets on housing 302 may be placed on the top surface of housing 302. In another embodiment, the plurality of electromagnets may be placed on the lateral walls of rotatable cylinder 306 and housing 302.

To rotate rotatable cylinder 306, the magnetic field produced by the plurality of electromagnets on rotatable cylinder 306 interacts with the magnetic field produced by electromagnets 310 on housing 302. The rotation of rotatable cylinder 306 is controlled by selectively switching polarities of the plurality of electromagnets on rotatable cylinder 306 or electromagnets 310 on housing 302. By using the one or more electromagnets on rotatable cylinder 306 and electromagnets 310 on housing 302, rotatable cylinder 306 may be rotated without contacting housing 302.

In addition to the plurality of electromagnets for rotating the one or more rotatable cylinders, apparatus 300 may further include a plurality of stabilizing electromagnets (not shown in FIG. 3) to prevent vibration of rotatable cylinder 306 when rotated. In one embodiment, a stabilizing electromagnet of the plurality of stabilizing electromagnets may include a superconducting magnet. The superconductivity associated with these superconducting magnets enables suspension of rotatable cylinder 306 at a fixed distance from housing 302, thereby preventing vibration of rotatable cylinder 306 during rotation.

In response to rotation of rotatable cylinder 306, perforations 308 frictionally interact with the fluids to produce one or more vapors and separate the one or more impurities from the fluids. Thereafter, the one or more impurities are collected in an impurity collector 312 and the generated one or more vapors are condensed and collected as one or more distilled fluids through a condenser 314 as explained in conjunction with FIG. 1.

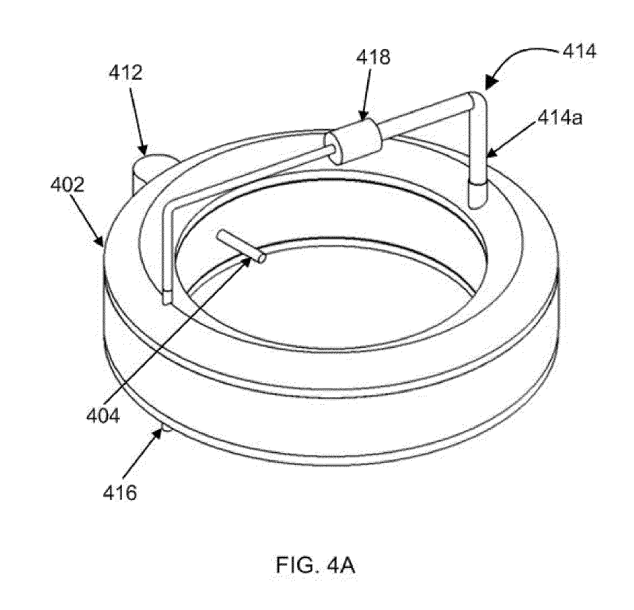

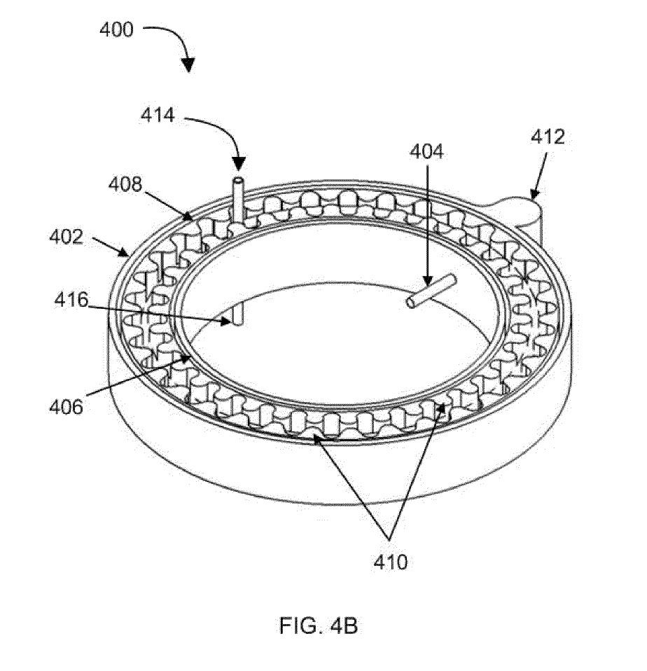

In another embodiment, the plurality of friction elements associated with the one or more rotatable cylinders may include corrugations. This embodiment is explained in conjunction with FIG. 4A and FIG. 4B. Accordingly, FIG. 4A and FIG. 4B illustrate a perspective view and a perspective inner view respectively of an apparatus 400 for distilling the fluids in accordance with another embodiment of the invention. Apparatus 400 includes a housing 402 for receiving the fluids. A fluid inlet 404 is configured to guide the fluids into housing 402. Here, the fluids may include one or more impurities. Apparatus 400 further includes one or more cylinders configured to rotate within housing 402. In an embodiment, the one or more rotatable cylinders include a rotatable cylinder 406 and a rotatable cylinder 408. Rotatable cylinder 406 and rotatable cylinder 408 are concentric to an axis of the housing 402. Further, each of the one or more rotatable cylinders may have both ends closed, both ends open, or one end closed and one end open.

Rotatable cylinder 406 and rotatable cylinder 408 include a plurality of friction elements on one or more of an inner wall and an outer wall. The plurality of friction elements may include a plurality of corrugations such as corrugations 410 associated with rotatable cylinder 406 and rotatable cylinder 408. For example, corrugations 410 may be present on an outer wall of cylinder 406 and on an inner wall of cylinder 408. The friction elements may further include, but are not limited to, perforations, grooves, arcs, teeth, and ridges. Corrugations 410 associated with rotatable cylinder 406 and rotatable cylinder 408 frictionally interact with the fluids in housing 402 on rotation of one or more of rotatable cylinder 406 and rotatable cylinder 408 to generate heat. For example, during operation, the fluids present in a gap between rotatable cylinder 406 and rotatable cylinder 408 are agitated or stirred by corrugations 410 to generate heat. This heat causes the fluids to evaporate as one or more vapors. Here, the fluids may form vapor at different temperatures corresponding to the boiling temperatures associated with the fluids.

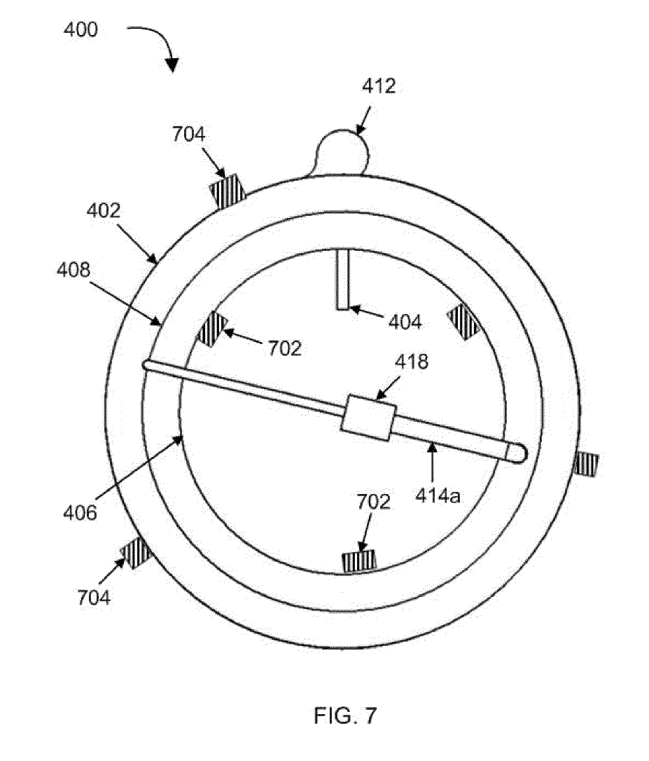

To rotate rotatable cylinder 406 and rotatable cylinder 408, a plurality of electromagnets may be used. Rotation of one or more of rotatable cylinder 406 and rotatable cylinder 408 using a plurality of electromagnets is explained in conjunction with FIG. 7. Here, rotatable cylinder 406 and rotatable cylinder 408 may be rotated in one or more of a clockwise direction and a counterclockwise direction. For example, rotatable cylinder 406 may be rotated in a clockwise direction and rotatable cylinder 408 may be rotated in a counterclockwise direction. Alternatively, rotatable cylinder 406 and rotatable cylinder 408 may be rotated in the same direction at different speeds. In another embodiment, one of rotatable cylinder 406 and rotatable cylinder 408 may be stationary and another rotatable cylinder may be rotated in one of a clockwise direction and a counterclockwise direction. It will be apparent to a person skilled in the art that the directions of rotation of rotatable cylinder 406 and rotatable cylinder 408 is not limited to the directions disclosed herein but may include other combinations of directions without moving away from the scope of the invention.

To stabilize one or more of rotatable cylinder 406 and rotatable cylinder 408 during rotation of one or more of rotatable cylinder 406 and rotatable cylinder 408, a plurality of stabilizing electromagnets may be provided. In other words, the stabilizing electromagnets prevent vibration of one or more of rotatable cylinder 406 and rotatable cylinder 408 during rotation of one or more of rotatable cylinder 406 and rotatable cylinder 408. In one embodiment, a stabilizing electromagnet of the plurality of stabilizing electromagnets may include a superconducting magnet. The superconductivity associated with these superconducting magnets enables suspension of one or more of rotatable cylinders, such as rotatable cylinder 406 and rotatable cylinder 408 at a fixed distance from housing 402. As a result, vibration of one or more of rotatable cylinder 406 and rotatable cylinder 408 during rotation can be avoided.

In response to rotation of one or more of rotatable cylinder 406 and rotatable cylinder 408, the centrifugal force generated causes the fluids to separate out into different rings based on the densities associated with each fluid. Thereafter, corrugations 410 associated with rotatable cylinder 406 and rotatable cylinders 408 frictionally interact with the fluids causing fluid friction and generating heat. The fluid friction caused as a result of frictional interaction between corrugations 410 and the fluids increases a temperature of the fluids. The increase in temperature of the fluids results in evaporation of the fluids as one or more vapors. The rotation of one or more of rotatable cylinder 406 and rotatable cylinder 408 further causes one or more impurities associated with the fluids to separate from the fluids and collect in an impurity collector 412 as explained in conjunction with FIG. 1.

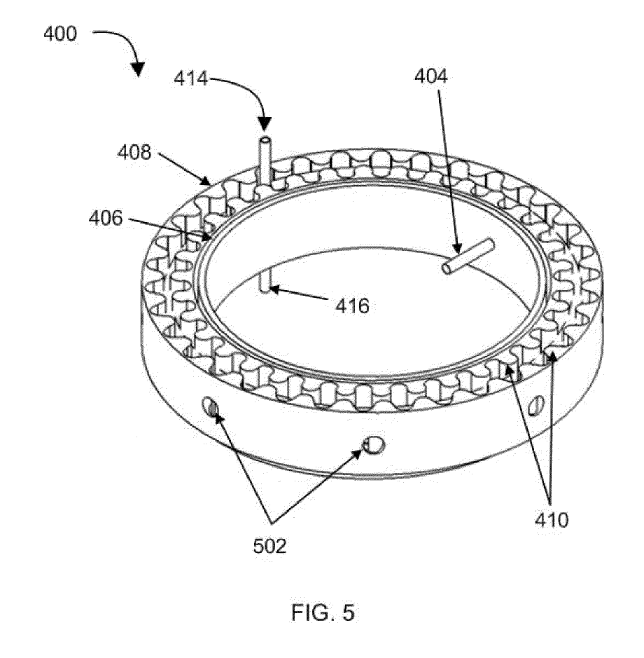

To enable the flow of the one or more impurities into impurity collector 412, one or more openings such as openings 502 as illustrated in FIG. 5 may be provided in one or more of rotatable cylinder 406 and rotatable cylinder 408. The one or more impurities may then be removed from impurity collector 412 by one or more of but not limited to a gravity settling and a filtration technique.

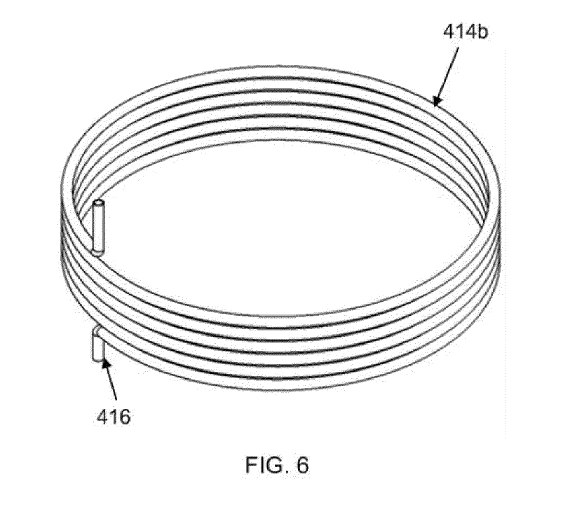

The one or more vapors generated as a result of frictional interaction of corrugations 410 is collected by one or more condensers such as a condenser 414. Condenser 414 includes a first portion 414a and a second portion 414b (illustrated in FIG. 6). Here, second portion 414b may include, but is not limited to a coil as illustrated in FIG. 6. Further, second portion 414b is configured to exchange heat with the fluids as explained in conjunction with second portion 414b of apparatus 100. Here, second portion 414b of condenser 414 may be positioned between the one or more rotatable cylinders to enable efficient exchange of heat with the fluids thereby condensing the one or more vapors to produce one or more distilled fluids. For example, second portion 414b of condenser 414 may be positioned between rotatable cylinder 406 and rotatable cylinder 408 to facilitate exchange of heat between the one or more vapors and the fluids. On condensing the one or more vapors, the distilled fluid may be collected at a fluid outlet 416 associated with condenser 414. The heat exchanged by condenser 414 with the fluids facilitates recirculation of heat back into apparatus 400.

Further, condenser 414 may include one or more compression units such as compression unit 418 for compressing the one or more vapors. Compression unit 418 compresses the one or more vapors to increase condensation temperature of the one or more vapors. The increased condensation temperature allows the one or more vapors to exchange heat with the fluids at a higher temperature as explained in conjunction with FIG. 1. Also, compression unit 418 facilitates reduction in boiling point of the fluids by exerting a vacuum on the fluids. Accordingly, compression unit 418 improves the exchange of heat between the one or more vapors and the fluids.

FIG. 7 illustrates the apparatus 400 using a plurality of electromagnets for rotating one or more of rotatable cylinder 406 and rotatable cylinder 408 in one of a clockwise direction and one of a counterclockwise direction. In an embodiment, an electromagnet of the plurality of electromagnets may include a superconducting magnet. In this case, the one or more superconducting magnets suspend the one or more rotatable cylinders at a fixed distance from each other and also from the housing. This facilitates contactless rotation of the one or more rotatable cylinders. Here, a plurality of electromagnets is placed on the one or more rotatable cylinders and a plurality of electromagnets are placed on the housing. For example, to rotate rotatable cylinder 406, a plurality of electromagnets such as electromagnets 702 may be placed on rotatable cylinder 406 and a plurality of electromagnets such as electromagnets 704 may be placed on housing 402. Similarly, a plurality of electromagnets may be placed on rotatable cylinder 408 to rotate rotatable cylinder 408. To rotate one or more of rotatable cylinder 406 and rotatable cylinder 408, a magnetic field produced by the plurality of electromagnets on one or more of rotatable cylinder 406 and rotatable cylinder 408 interacts with the magnetic field produced by electromagnets 704 on housing 402. The rotation of rotatable cylinders 406-408 is controlled by selectively switching polarities of the plurality of electromagnets on rotatable cylinders 406-408 or electromagnets 704 on housing 302. By using the plurality of electromagnets on rotatable cylinders 406-408 and electromagnets 704 on housing 302, one or more of rotatable cylinder 406 and rotatable cylinder 408 may be rotated without contacting housing 402.

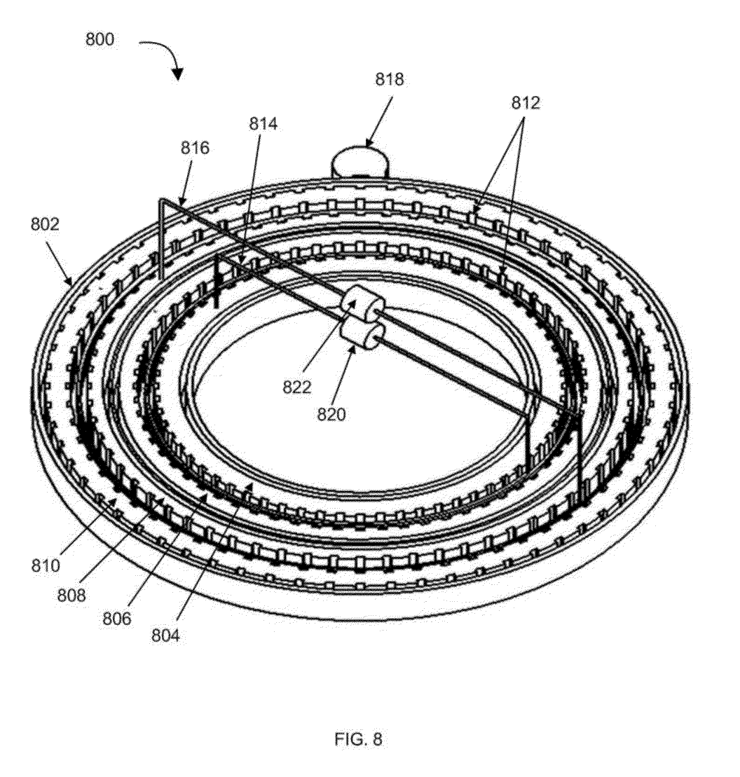

FIG. 8 illustrates a perspective view of an apparatus for distilling one or more fluids in accordance with another embodiment of the invention. Apparatus 800 includes a housing 802 for receiving the one or more fluids (hereinafter referred to as “fluids”). Apparatus 800 further includes one or more rotatable cylinders such as rotatable cylinders 804-810 configured to be rotatable within housing 802. Here, rotatable cylinders 804-810 are positioned concentric to an axis of the housing 402.

Rotatable cylinders 804-810 include a plurality of friction elements such as grooves 812 on one or more of an inner wall and an outer wall. For example, grooves 812 may be associated with an outer wall of rotatable cylinder 804, an inner wall of rotatable cylinder 806, an outer wall of rotatable cylinder 808 and an inner wall of rotatable cylinder 810. It will be apparent to a person skilled in the art that the placement of grooves 812 of rotatable cylinders 804-810, is not limited to the configuration disclosed herein but may be configured in any other combination.

During operation of apparatus 800, rotatable cylinders 804-810 are rotated in one or more of a clockwise direction and a counterclockwise direction. Here, rotatable cylinders 804-810 may be rotated by, but not limited to, a plurality of electromagnets as explained in conjunction with FIG. 7. In response to rotation, a centrifugal force is generated. The centrifugal force causes the fluids to separate out into different rings based on the densities associated with each fluid. Also, on rotation of rotatable cylinders 804-810, grooves 812 associated with rotatable cylinders 804-810 frictionally interact with the fluids to produce one or more vapors and separate one or more impurities from the fluids. Thereafter, the one or more vapors are condensed using one or more condensers such as a condenser 814 and a condenser 816 and collected as one or more distilled fluids and the one or more impurities are collected separately by an impurity collector 818. Here, condenser 814 and condenser 816 may include one or more compression units such as a compression unit 820 and a compression unit 822 respectively to enhance condensation and heat exchange as explained in conjunction with FIG. 4. Here, the housing 802, condensers 814 and 816, impurity collector 818, compression units 820 and 822, are structurally and functionally similar to housing 402, impurity collector 412, condenser 414, and compression unit 418 as explained in conjunction with FIG. 4.

Various embodiments of this disclosure provide a fluid friction-based distillation and processing system for distilling one or more fluids. Here, the one or more fluids need not be pre-treated before being processed in the apparatus. Also, the apparatus discharges pure fluid with no fluids wasted as effluents and the impurities are discharged as crystals and solids. Further, the heat generated from the generation of one or more vapors is re-circulated to the one or more fluids thereby reducing the cost associated with distilling the one or more fluids. Further, a plurality of electromagnets may be used to provide contactless rotation to the one or more cylinders thereby reducing cost and mechanical wear of the apparatus. The apparatus further provides a plurality of stabilizing electromagnets for preventing large rotatable cylinders from vibrating and damaging the apparatus.

Those skilled in the art will realize that the above recognized advantages and other advantages described herein are merely exemplary and are not meant to be a complete rendering of all of the advantages of the various embodiments of the present invention.

In the foregoing specification, specific embodiments of the present invention have been described. However, one of ordinary skill in the art appreciates that various modifications and changes can be made without departing from the scope of this disclosure as set forth in the claims below. Accordingly, the specification and figures are to be regarded in an illustrative rather than a restrictive sense, and all such modifications are intended to be included within the scope of this disclosure. The benefits, advantages, solutions to problems, and any element(s) that may cause any benefit, advantage, or solution to occur or become more pronounced are not to be construed as a critical, required, or essential features or elements of any or all the claims. This disclosure is defined solely by the appended claims including any amendments made during the pendency of this application and all equivalents of those claims as issued.

What is claimed is:

1. An apparatus for distilling a at least one fluid, the apparatus comprising:
a housing to receive at least one fluid, wherein the at least one fluid comprises at least one impurity;
at least one rotatable cylinder enclosed within the housing, wherein a rotatable cylinder comprises a plurality of friction elements on at least one of an inner wall and an outer wall of the rotatable cylinder, wherein in response to rotation of the at least one rotatable cylinder, the at least one impurity is separated from the at least one fluid and the plurality of friction elements frictionally interact with the at least one fluid to generate at least one vapor and;
an impurity collector associated with the housing to collect the at least one impurity separated from the at least one fluid; and
at least one condenser to receive the at least one vapor from the housing, wherein the at least one condenser condenses the at least one vapor to produce at least one distilled fluid.

2. The apparatus of claim 1 further comprising a fluid inlet for guiding the at least one fluid to the housing.

3. The apparatus of claim 1, wherein the at least one rotatable cylinder is concentric to an axis of the housing.

4. The apparatus of claim 1, wherein the at least one rotatable cylinder comprises at least one opening for guiding the at least one impurity to the impurity collector associated with the housing.

5. The apparatus of claim 1, wherein the at least one impurity comprises at least one of at least one suspended solid and at least one dissolved solid.

6. The apparatus of claim 5, wherein the at least one dissolved solid is separated from the at least one fluid as a precipitate in response to generation of the at least one vapor.

7. The apparatus of claim 5, wherein the at least one suspended solid is collected in the impurity collector in response to the rotation of the at least one rotatable cylinder.

8. The apparatus of claim 1, wherein a friction element of the plurality of friction elements comprises at least one of a perforation, a corrugation, a groove, an arc, a pair of teeth, and a ridge.

9. The apparatus of claim 1 further comprising at least one of at least one motor and a plurality of electromagnets for rotating the at least one rotatable cylinder.

10. The apparatus of claim 9, wherein an electromagnet of the plurality of electromagnets is a superconducting magnet.

11. The apparatus of claim 9, wherein the at least one of at least one motor and at least one electromagnet rotates the at least one rotatable cylinder in at least one of a clockwise direction and a counterclockwise direction.

12. The apparatus of claim 1 further comprising a plurality of stabilizing electromagnets for stabilizing the at least one rotatable cylinder.

13. The apparatus of claim 12, wherein an electromagnet of the plurality of stabilizing electromagnets is a superconducting magnet.

14. The apparatus of claim 1, wherein the at least one condenser is configured to exchange heat with the at least one fluid.

15. The apparatus of claim 1, wherein the at least one condenser comprises at least one compression unit for compressing the at least one vapor.

16. The apparatus of claim 1, wherein the at least one condenser comprises a fluid outlet to discharge the at least one distilled fluid.
